(19) United States
(12) Patent Application Publication
(10) Pub. No.: US 2002/0106081 A1
(43) Pub. Date: Aug. 8, 2002

(54) Multiple registration system and method of using the same account for registering different device to a DRC server

(76) Inventor: Ta-Kuang Yang, Taipei (TW)

Correspondence Address: RABIN & BERDO, P.C., Suite 500, 1101 14th Street, N.W., Washington, DC, 20005, US

(21) Appl. No.: 10/026,438

(22) Filed: Dec. 27, 2001

(30) Foreign Application Priority Data
Dec. 28, 2000 (TW) 89128086

(51) Int. Cl. H04N 7/167

(52) U.S. Cl. 380/201; 713/168

(57) ABSTRACT

A multiple registration system of using the same account for a user to register different devices to a DRC (digital right certificate) server for further downloading a digital content from the network is disclosed. The system comprises a first device, which includes a first reader and a first device identity code, a second device, which includes a second reader and a second device identity code, and the DRC server. The first device and the second device can build connections with the DRC server through the network. The DRC server is for providing the first or/and the second device to apply an account and to use the same account for further downloading the digital content. During registration, the reader stores the account and an identity code of its own device in its own right record file. When the reader starts retrieving the digital content for reading, in order to prevent illegal copy and distribution, it will check if the right record file has been modified, and check if the identity code in the right record file matches correctly with the device code of the present device in use.

This application incorporates by reference Provisional application Serial No. 89128086, Filed Dec. 28, 2000.

### BACKGROUND OF THE INVENTION

1. Field of the Invention

This invention relates to a system and a method of registration and usage of an account, and more particularly to a system and a method capable of using the same account for registering different devices to a DRC (Digital Right Certificate) server through a network system.

2. Description of the Related Art

As the continuous improvement of computer technology, the applications of computers and the network have not only been limited in delivering or sharing information, but also gradually change commercial trading behaviors of consumers. In the past, consumers had to go to a shopping center personally to choose goods and proceed with a trade. As the fast development of computer network, consumers can use the E-Commerce in the Internet to buy goods now. And the supplier will deliver the sold goods to a consumer by a delivery company. In addition, a consumer can also use E-Commerce to buy a digital content, such as e-book, digital music such as MP3, or a system and software of computer application, and so on. A consumer can directly download the ordered digital content from the Internet. This trading method seems to be very convenient and effective for both consumers and suppliers.

However, before the download process of the ordered digital content to the corresponding consumer, a supplier would proceed with encryption on the associated digital content in order to prevent illegal copy or unauthorized distribution. Afterwards, the supplier would then allow the download procedure by showing a download manual to consumers. In this way, the supplier can prevent the consumer from using the downloaded digital content in another machine or device, and consequently can prevent the illegal copy or unauthorized distribution of the digital content. However, by doing so, the consumer's legal right and benefit would also be restricted a lot at the same time.

### SUMMARY OF THE INVENTION

It is therefore an object of the invention to provide a system and a method of using the same account for multiple registrations in different devices. The present invention enables a user to perform multiple registrations of the same account to a server in different devices The downloaded digital content can therefore be legally utilized in all the authorized devices, and not limited to only one single device. However, at the same time, the present invention can still achieve the important goal of preventing illegal copy or distribution to unauthorized or unregistered devices.

The object of this invention is to provide a method of using the same account for multiple registrations indifferent devices. The method enables a user to proceed the registration procedure to a digital right certificate (DRC) server in a first device, in order to purchase and download a digital content through a network. In the first device, there is already a first reader or program installed for the user to open the downloaded digital content. The associated method of this invention firstly, at Step A, installs the first reader into the first device, then builds connection between the first reader and the DRC server through a network system, and begins the further registration procedure. At Step B, the DRC server generates a user identity (UID), encrypts the UID, and then transmits it to the first reader. At this step, the first reader further stores the UID and a first device identity code in an encrypted first right record file. Whenever necessary, the UID can be retrieved or read out through the first reader by the user. Then at Step C, the first reader transmits the first device identity code to the DRC server. The first right record file and the first device identity code therein help the identification process, and then decide whether to start decryption or not. That is, when the first reader is initiated to begin decryption, it checks if the first right record file has been changed, and then checks if the first device identity code in the first right record file is correct or not.

Then, a user can further use a second device to register to the DRC server by using the aforementioned UID. The method of this invention further comprises step D: installing a second reader in the second device, and inputting the UID into the second reader. The second reader would then store the UID and a second device identity code in an encrypted second right record file. Furthermore, at step E, the second reader transmits the UID and the second device identity code to the DRC server. Finally, at Step F, the DRC server transmits all digital right coupons of the specific digital contents that the user purchased to the second reader. And the second reader stores the coupons in the second right record file.

The invention achieves the above-identified object by further providing a system for using the same account for multiple registrations in different devices. The system enables a user to use the same account in different devices and to purchase and download a digital content via a network. The system comprises a first device and a DRC server. The first device comprises a first reader and a first device identity code. The first device can build connection with the DRC server through the network. And the DRC server is aimed at providing and controlling the related registration procedures when the first device applies for an account or a user identity (UID). The aforementioned system uses the first reader to encrypt the UID and the first device identity code, and to store them into a first right record file, and then to transmit the UID and the first device identity code to the DRC server. The first right record file and the first device identity code therein help the identification process, and then decide whether to start decryption or not. That is, when the first reader is initiated to begin decryption, it first checks if the first right record file has been changed, and then check if the first device identity code in the first right record file is correct.

In addition, the system of the present invention further comprises a second device. The second device includes a second reader and a second device identity code. The second device builds connection with the DRC server through the network. The user, who wishes to apply multiple registrations, can then input the same UID into the second reader. The second reader encrypts and stores the UID and the second device identity code in a second right record file. And the second device identity code is also transmitted to the DRC server. The second right record file and the second device identity code therein also help the identification process, and then decide whether to start decryption or not. That is, when the second reader is initiated to begin decryption, it will firstly check if the second right record file has been changed, and then check if the second device identity code in the second right record file is correct or not.

### BRIEF DESCRIPTION OF THE DRAWINGS

Objects, features, and advantages of the invention will become apparent from the following detailed description of the preferred but non-limiting embodiments. The description is made with reference to the accompanying drawings, in which:

FIG. 1 is a system structure diagram of one preferred embodiment of the system capable of using the same account for multiple registrations in different devices

FIG. 2 is a flow chart of the process steps for the first device in FIG. 1 to register to a DRC server and receive a user account.

FIG. 3 is an illustration of content format of a digital right coupon corresponding to a digital content.

FIG. 4 is a flow chart of the process steps for the second device in FIG. 1 to use the same registration account in the first device to perform multiple registrations to the DRC server.

### DESCRIPTION OF THE PREFERRED EMBODIMENT

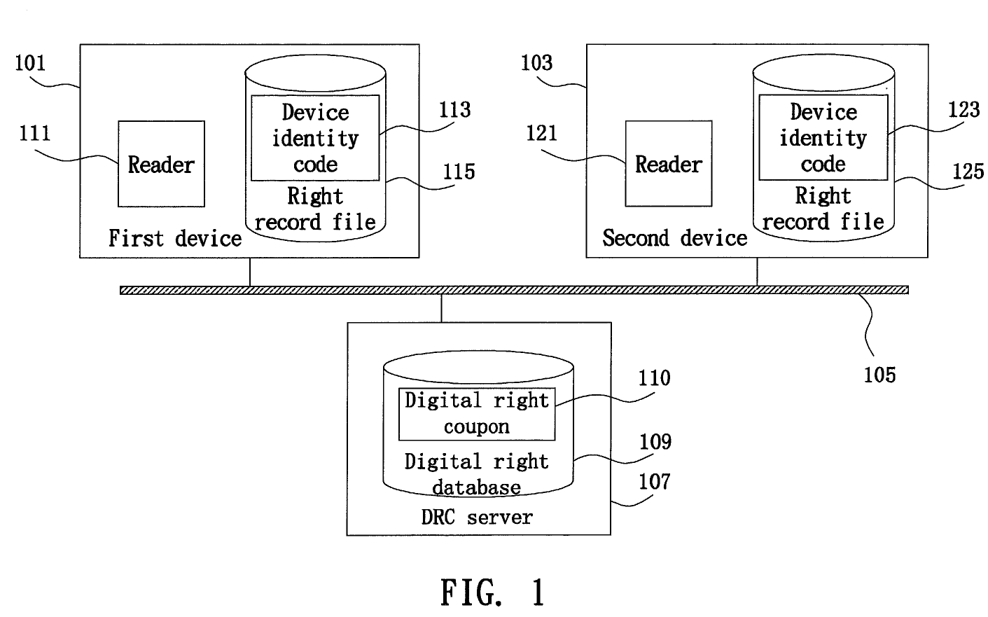

Please refer to FIG. 1. FIG. 1 is a system structure diagram of one preferred embodiment of the system of using the same account for multiple registrations in different devices. In FIG. 1, the first device 101 and the second device 103 can build connections with a digital right certificate (DRC) server 107 through the network 1105. The first device 101 and the second device 1103 can either be a personal computer, a notebook, a laptop, a personal digital assistant (PDA), a smart phone, or a device capable of receiving or transmitting message through wired or wireless network. The DRC server 107 performs the functions of controlling, managing and maintaining user's registration data, the record and rights of the purchased digital contents by a user. The user can proceed the registration procedure to the DRC server 107 via the first device 101 or the second device 103.

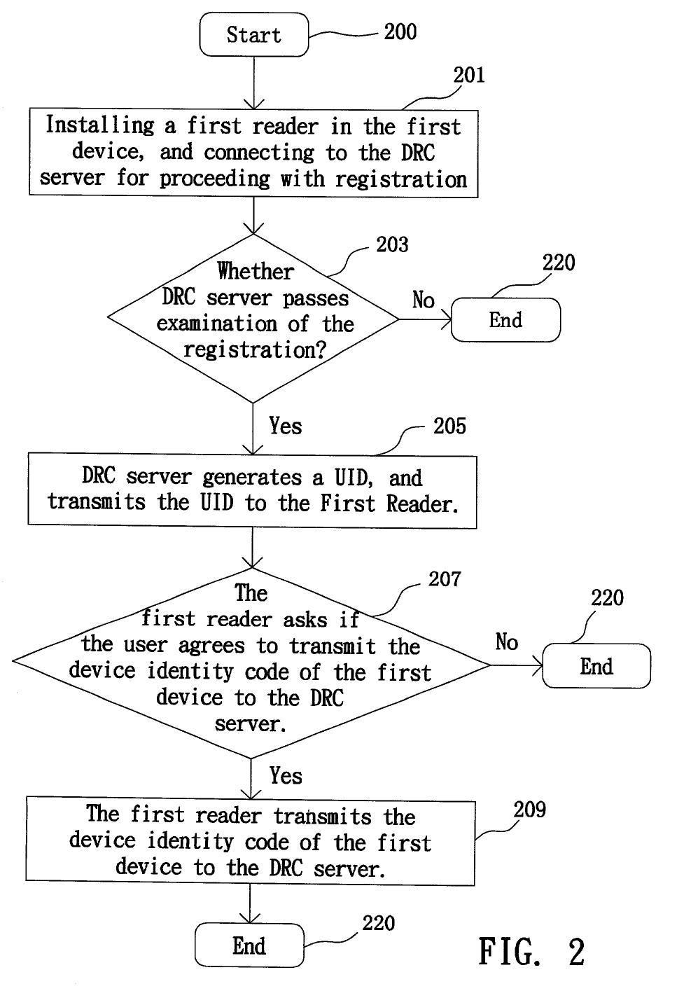

The system of the present invention utilizes reader programs 111, 121 to perform multiple registrations of the same account in different devices 101, 103. Please refer to FIG. 2. FIG. 2 is a flow chart of the process steps for the first device 101 in FIG. 1 to register to a DRC server 107 and receive a user account. In FIG. 2, at Step 201, it shows to install a reader 111 in the first device 101, and to build connection with the DRC server 107 to begin the registration process. The user can download the reader 111 from the DRC server 107 or related network shops and fill registration data. The registration data includes the user's name, age, address or other related information.

At Step 203, the DRC server 107 examines and checks the user's registration data. If the examination is passed and approved, the method proceeds to Step 205; otherwise, this method ends. At this step, the DRC server 107 also checks to see if the user's registration data is enough and correct.

At Step 205, after the registration is approved, the DRC server 107 generates a user's identity (UID) to represent the user's account for further identification. As shown in FIG. 1, the DRC server 107 further comprises a digital right database 109. The DRC server 107 stores the UID in the digital right database 109. Then, the DRC server 107 transmits the UID to the reader 111. For securely delivering the UID through the network, the DRC server 107 encrypts UID and then transmits the UID to the reader 111. The reader 111 stores the UID and a device identity code 113 of the first device 101 in a rights record file 115, which is an encrypted file. It is possible for the user to retrieve or read out the exact value of UID through the reader 111, but the user has no way to change it. Besides, the device identity code 113 can be a serial number of a hard disk drive, an identified number of a CPU, a card number of a network card or other unique serial number of hardware parts in the first device 101.

At Step 207, the reader 111 asks if the user agrees to transmit the device identity code 113 to the DRC server 107. It is done because of the privacy policy concern. If the user agrees, the method proceeds to Step 209, otherwise, the procedure is ended.

At Step 209, the reader 111 transmits the device identity code 113 to the DRC server 107. The DRC server 107 stores the device identity code 113 in the digital right database 109. When the aforementioned procedures are finished, the registration process of the first device 101 is completed.

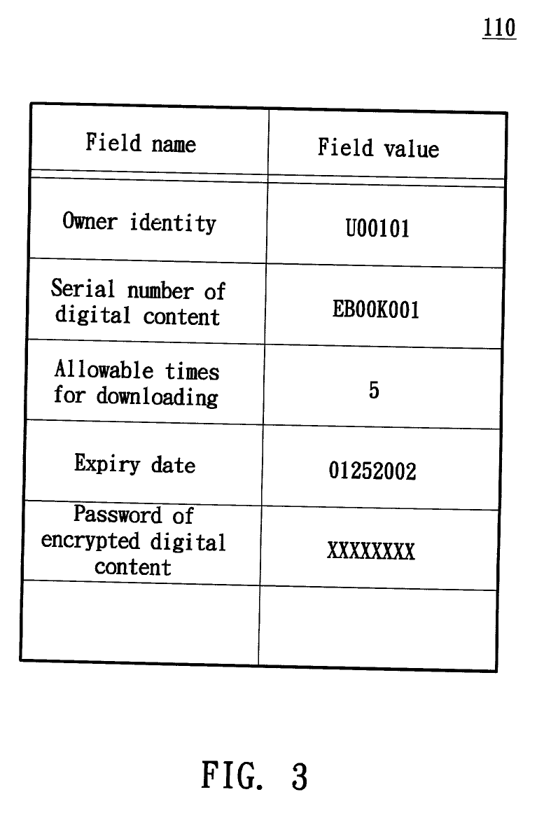

Afterwards, the user can use the first device 101 to order and download a desired digital content. Before the desired digital content is downloaded, the server 107 that supplies downloadable digital contents uses a unique encryption key to encrypt this digital content. Then the encrypted digital content can be downloaded to the first device 101. There is an accompanied digital right coupon 110 in association with the corresponding digital content for recording the associated digital rights and related information for this particular UID to use the digital content. And the digital right coupon 110 is stored in the digital right database 109 of the DRC server 107. Please refer to FIG. 3. FIG. 3 is an illustration of content format of the digital right coupon 110. As shown in FIG. 3, the content format of the digital right coupon 110 comprises at least the following fields: owner identity, serial number of digital content, allowable times for downloading, expiry date, password of encrypted digital content.

The field for an owner identity of the digital right coupon 110 can be the UID of the corresponding user who purchases the digital content. The field of the serial number of a digital content is the unique serial number for this particular downloaded digital content. The field of allowable times for downloading is for recording times for the user to download this particular digital content. For example, when a user purchases a digital content with a right of 5 times download permission, then the value is 5. Afterwards, every time when the user uses a different device to download the digital content, this value would be subtracted one. If the user uses the same device to download the same digital content again, this value remains the same and would not change. And the filed of expiry date is for recording the expiration date of the digital content wherein the user is authorized to use this digital content. The field of password of encrypted digital content is for recording a necessary password when the user uses the first reader to open the digital content. This password is corresponding to the encryption key to encrypt this particular digital content to be downloaded.

Then the first device 101 downloads an encrypted digital right coupon 110 in associated with the particular digital content and stores it into the right record file 113 in the first device 101.

The reader 111 further comprises a checking procedure. When the reader 111 is initiated to begin decrypting a digital content, it would start the checking procedure to see if the right record file 115 is an original file downloaded from a DRC server 107. If the right record file 115 is fabricated or modified, the checking procedure would stop the normal execution of the reader 111. In addition, the reader 111 would also check the device identity code of the present device. If the present device code is different from the device identity code 113 already stored in the right record file 115, that means, the right record file 115 is copied from another device. Therefore, the reader 111 would not continue to perform the normal execution and then terminate.

After the right record file 115 is checked and the reader 111 is then to open a downloaded digital content, the reader 111 would still check the digital right coupon of the digital content in the right record file 115. This is for the examination of the expiry day thereon. If the digital right coupon of the digital content is expired, the reader 111 would not open the expired digital content. If the coupon is within the expiry date, the reader 111 would read the password of the encrypted digital content from the filed of the password of encrypted digital content, and then perform decryption and open the encrypted digital content.

However, when a user tries to use or read the digital content in the second device 103 or other devices, that user needs to install a reader in that device first. And after registering that device to the DRC server 107, the user can then open the digital content. Please refer to the following description how the other devices are registered to the DRC server 107.

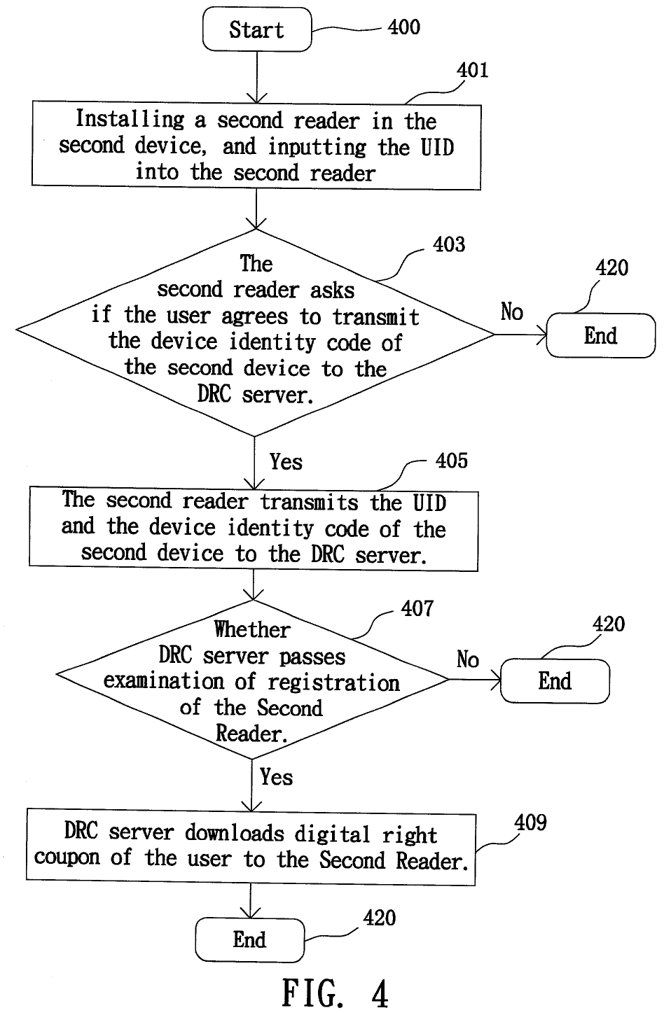

Please refer to FIG. 4. FIG. 4 illustrates a flow chart of the process steps for the second device 103 in FIG. 1 to use the same registration account (UID) in the first device 101 to perform multiple registrations to the DRC server 107. At Step 401, the user first installs a reader 121 in the second device 103, and inputs the same registration account UID into the reader 121. The UID can be retrieved and read out from the reader 111 in the first device 101, and the value of the UID can be inputted into the reader 121. At this step, the reader 121 stores the UID and a device identity code 123 of the second device 103 in a right record file 125. The right record file 125 is an encrypted file. And the device identity code 123 can be a serial number of a hard disk drive, an identity number of a CPU, a card number of a network card or other unique serial number of hardware parts of the second device 103.

At Step 403, the reader 121 asks if the user agrees to transmit the device identity code 123 to the DRC server 107 in order to proceed the further registration. This is also done due to the privacy policy concern. If yes, then the method proceeds to Step 405. Otherwise, the registration procedure of the second device 103 is ended.

At Step 405, the reader 121 transmits the UID and the device identity code 123 to the DRC server 107. The DRC server 107 would store the device identity code 123 in the digital right database 109.

Afterwards, at Step 407, the DRC server 107 examines and checks the registration of the second device 103. If the DRC server 107 approves the registration of the second device 103, then the method proceeds to Step 309; otherwise, the registration procedure of the second device 103 is ended. During this step, the DRC server 107 examines the rights of the user recognized as UID, by checking if the UID is still within its expiry date, and if the UID has the right for fetching the digital content in other different devices.

At Step 409, the DRC server 107 transmits all the digital right coupons of the associated digital contents, which the user purchased in the original register account of UID, to the second device 103. After the reader 121 receives these digital right coupons and stores them in the right record file 125, the second device 103 can download those purchased digital contents from the DRC server 107. Then the reader 121 checks the right record file 125 and opens the downloaded digital content. Basically, the processing principle of the reader 121 is the same as the aforementioned process of the reader 111 in the first device 101.

The present invention revealed by the above embodiments has two advantages.

(1) To protect the right of suppliers: the invention provides the function of avoiding illegally copy or distribution of a digital content. Because the reader in this invention would check user's identity, a device identity code and the password of an encrypted digital content when the reader opens a digital content. If there is any illegal copy, the digital content cannot be opened.

(2) To enhance the convenience of a user: the present invention enables a user, after purchasing and downloading a digital content, to use the digital content in different devices which previously have passed the registration approval and examination procedure. That means, the digital content is not limited to only one single device usage, and at the same time not breaking the supplier's security policy.

While the invention has been described above, by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multiple registration method of using the same account for registering different devices to a digital right certificate (DRC) server, enabling a user to register a first device to the DRC server in order to order and download a digital content through a network, wherein the user uses a first reader to open the digital content, the method comprising:
A. installing the first reader into the first device to build connection with the DRC server for further registration;
B. the DRC server generating a user identity (UID), encrypting the UID, and then transmitting the UID to the first reader, wherein the first reader stores the UID and a first device identity code in an encrypted first right record file, and the UID is capable of being retrieved from the first reader; and
C. the first reader transmitting the first device identity code to the DRC server,
wherein when the first reader is initiated, the first reader checks if the first right record file has been changed, and then checks if the first device identity code in the first right record file is correct.

2. The method according to claim 1, wherein the method between the step A and step B further comprises:
A1. the DRC server performing examination of registration of the first device.

3. The method according to claim 1, wherein the method between the step B and step C further comprises:
B1. the first reader asking if the user agrees to transmit the first device identity code to the DRC server; if yes, proceeding to step C; otherwise, ending this method.

4. The method according to claim 1, wherein when the first reader downloads the digital content, the first reader also downloads a digital right coupon and stores the coupon in the first right record file, wherein the digital right coupon records expiry date of the UID to use the digital content and a password of the encrypted digital content.

5. The method according to claim 4, wherein the digital right coupon further comprises a field for an owner identity, a field for a serial number of a digital content, a field for allowable times for downloading, a field for expiry date, and a field for password of encrypted digital content, wherein value of the filed for an owner identity is the UID, the field for a serial number of a digital content is a unique serial number of the digital content, the field of allowable times for downloading is for recording times for the UID being authorized to download the digital content, the filed of expiry date is for recording the expired date of the UID being authorized to use the digital content, and the field of password of the encrypted digital content is for recording the password for the UID to use the first reader to open the digital content.

6. The method according to claim 1, further comprises:
d. installing a second reader in a second device, and inputting the UID into the second reader, wherein, the second reader stores the UID and a second device identity code in an encrypted second right record file.
e. the second reader transmitting the UID and the second device identity code to the DRC server, and
f. the DRC server transmitting digital right coupons of all purchased digital contents by the user to the second reader, and the second reader storing the digital right coupons in the second right record file.

7. The method according to claim 6, wherein the method between the step D and step E further comprises:
D1. the second reader asking if the user agrees to transmit the second device identity code to the DRC server; if yes, proceeding to the step E; otherwise, ending the method.

8. The method according to claim 6, wherein the method between the step E and step F further comprises:
E1. the DRC server performing examination of registration of the second device.

9. The method according to claim 6, wherein the digital right coupons of all purchased digital contents are for recording expiry date of the UID to use the corresponding digital content and a password of the encrypted digital content, and the digital right coupons are stored in the second right record file.

10. The method according to claim 6, wherein the DRC server further comprises a digital right database for recording the UID, the first device identity code, and the second device identity code.

11. A multiple registration system for a user to use the same account for registering different devices to further order and download a digital content through a network, the system comprising:
a first device, comprising a first reader and a first device identity code; and
a digital right certificate (DRC) server, for providing the first device to apply for the account when the first device builds connection with the DRC server through the network;
wherein the system uses the first reader to encrypt and store the account and the first device identity code in a first right record file, and then to transmit the account and the first device identity code to the DRC server for completing the registration, and when the first reader is initiated, the first reader checks if the first right record file has been changed, and then checks if the first device identity code in the first right record file is correct.

12. The system according to claim 11, wherein when the first reader downloads the digital content, the first reader also downloads a digital right coupon corresponding to the digital content, and the digital right coupon comprises:
a field for an owner identity for recording the UID,;
a field for a serial number of a digital content for recording the unique serial number of the digital content;
a field for allowable times for downloading for recording times for the UID being authorized to download the digital content;
a field for expiry date for recording the expired date of the UID being authorized to use the digital content, and
a field for password of encrypted digital content for recording a password for the first reader to open the digital content;
wherein while the first reader opens the digital content, the first reader firstly checks the digital right coupon if the expiry date of the digital content is overdue according to the filed of the expiry date, and then the first reader retrieves the password from the filed of the password of encrypted digital content in order to open the digital content.

13. The system according to claim 12, wherein the digital right coupon is stored in the first right record file.

14. The system according to claim 11, the system further comprises a second device including a second reader and a second device identity code, enabling the user to register the second device connecting to through the network, wherein the user retrieves the account from the first reader and inputs the account into the second reader, the second reader encrypts and stores the account and the second device identity code in a second right record file and also transmits the account and the second device identity code to the DRC server for completing the registration, and when the second reader is initiated, the second reader checks if the second right record file has been modified, and then check if the second device identity code in the second right record file is correct.

15. The system according to claim 14, wherein after the second device completes the registration, the user uses the second reader to download digital right coupons of all purchased digital contents by the user from the DRC server, and each of the digital right coupons individually comprises:
a field for an owner identity for recording the account;
a field for a serial number of a digital content for recording the unique serial number of the related digital content;
a field for allowable times for downloading for recording times for the account being authorized to download the related digital content;
a field for expiry date for recording the expired date for the account being authorized to use the related digital content, and
a field for password of an encrypted digital content for recording a password for the second reader to open the corresponding digital content;
wherein while the second reader opens a digital content, the second reader firstly checks a digital right coupon of the digital content if the expiry date of the digital content is overdue according to the filed of the expiry date, and then the second reader retrieves a password of the digital content from the filed of the password of digital content in order to open the digital content.

16. The system according to claim 15, wherein the digital right coupon is stored in the second right record file.

17. The system according to claim 11, wherein, the DRC server further comprises a digital right database for storing the UID and the first device identity code.

18. A method for a user to use the same account and readers installed in a plurality of devices to open a digital content downloaded from a DRC (Digital Right Certificate) server, the method comprising:
A. connecting and registering a first device to the DRC server, and downloading the digital content,
B. the DRC server generating a user identity (UID), encrypting the UID, and then transmitting the UID to the reader of the first device, wherein the reader of the first device stores the UID and a first device identity code in a first right record file, and transmits the first device identity code to the DRC server; and
C. inputting the UID to a second device, the reader of the second device stores the UID and a second device identity code to a second right record file, and transmits the second device identity code to the DRC server;
wherein when any reader of the first or the second device is initiated, the reader checks if the right record file of the present device has been modified, and then check if the corresponding device identity code matches the device identity code of the present device.

19. The method according to claim 18, wherein when the reader downloads the digital content, the reader download a digital right coupon corresponding to the digital content, and the digital right coupon comprises:
a field for an owner identity for recording the UID;
a field for a serial number of a digital content for recording a unique serial number of the digital content;
a field for allowable times for downloading for recording times for the UID being authorized to download the digital content;
a field for expiry date for recording the expired date of the UID being authorized to use he digital content, and a field for password of a encrypted digital content for recording a password for the reader to open the digital content;
wherein while the reader opens the digital content, the reader firstly checks the
